(19) United States
(12) Patent Application Publication
(10) Pub. No.: US 2014/0122638 A1
(43) Pub. Date: May 1, 2014

(54) Webpage Browsing Method And Device

(71) Applicant: TENCENT TECHNOLOGY (SHENZHEN) COMPANY LIMITED, Shenzhen (CN)

(72) Inventors: Wenjun GAO, Shenzhen (CN); Junjun JANG, Shenzhen (CN); Ming HE, Shenzhen (CN); Lei CHEN, Shenzhen (CN)

(73) Assignee: TENCENT TECHNOLOGY (SHENZHEN) COMPANY LIMITED, Shenzhen (CN)

(21) Appl. No.: 14/150,432

(22) Filed: Jan. 8, 2014

Related U.S. Application Data
(63) Continuation-in-part of application No. PCT/CN2012/077590, filed on Jun. 27, 2012.

(30) Foreign Application Priority Data
Jul. 8, 2011 (CN) 201110190961.X

(51) Int. Cl. H04L 29/08

(52) U.S. Cl. CPC H04L 67/2842
USPC 709/213

(57) ABSTRACT

A webpage browsing method including a browser of mobile terminal device accesses a server through the Internet in a first working state, downloads data of a current page and data of predefined N pages subsequent to the current page in order from the server, caches the downloaded data and displays the current page, wherein N is a natural number. The browser updates a link address of each page on the server into a cache address corresponding to data of the page, and disconnects from the Internet after the data of the current page and the data of the N pages have been cached. The browser switches to a second working state, selects one page of the cached current page and the N pages, reads the data of the selected page from a cache according to a cache address corresponding to data of the selected page, and displays the selected page.

### CROSS-REFERENCE TO RELATED APPLICATIONS

This application is a continuation of International Application No. PCT/CN2012/077590, filed on Jun. 27, 2012. This application claims the benefit and priority of Chinese patent application No. 201110190961.X, filed on Jul. 8, 2011. The entire disclosures of each of the above applications are incorporated herein by reference.

### FIELD

The present disclosure relates to computer technologies and to a webpage browsing method and device.

### BACKGROUND

This section provides background information related to the present disclosure which is not necessarily prior art.

With the development of computer communication technologies and Internet technologies, more and more users would like to obtain information from the Internet in daily life and work. For example, making use of a mobile terminal device, a user sends a Hypertext Transfer Protocol (HTTP) request or a Wireless Application Protocol (WAP) request to a web server according to a Uniform Resource Locator (URL), and obtains graphic information including a rich text from the web server. The mobile terminal device may be a personal computer or a mobile phone which includes a built-in wired or wireless browser. The web server may provide a webpage link including a rich text.

Taking a mobile terminal device for instance, a method for browsing a rich text through a browser of the mobile terminal device is illustrated hereinafter. Herein, the mobile terminal may be a mobile phone or a Personal Digital Assistant (PDA).

FIG. 1 is a flowchart illustrating a method for browsing rich text through a browser of a mobile terminal device. The method includes following blocks.

At block 101, a browser of a mobile terminal device accesses a webpage including a rich text.

In this block, a user opens the browser of the mobile terminal device. At this time, the browser may access the webpage including the rich text according to a link address of the webpage input by the user.

At block, 102, data of a current page on the webpage is downloaded online.

In this block, the browser of the mobile terminal device downloads data of the rich text included in the current page.

In an implementation, if the data of the rich text to be browsed by the user is too much, the data of the rich text may be divided into multiple pages according to the screen size of the browser of the mobile terminal device, and each page is configured with a link control of next page, a link control of last page and a close link control. For example, when the user clicks the link control of next page set on the current page, the browser of the mobile terminal device is triggered to open the next page of the current page, and downloads the data of the rich text on the next page. Link information of next page is link address information of next page on the webpage.

At block 103, the browser of the mobile terminal device displays the downloaded current page, thereby being browsed by the user.

In this block, when the browser of the mobile terminal device downloads the data of the current page, the mobile terminal device is always connected to the Internet.

At block 104, the link information of next page is responded, the data of the next page is downloaded and the next page is displayed.

In this block, after browsing the downloaded current page, the user may click the link control of next page set on the current page, downloads the data of the next page and displays the next page, thereby being browsed by the user. The cycle continues until the rich text has been browsed or the user stops browsing.

At block 105, close information input by the user is received, the webpage is disconnected and the browsing is stopped.

In this block, when the user has browsed the last page of the rich text or decides to stop browsing, the user may click the close control set on the current page, so as to output close information, stop browsing and disconnect from the Internet.

As can be seen, in the method for browsing the rich text through the browser of the mobile terminal device, it is necessary that the mobile terminal device is always connected to the Internet during the process of browsing the page data of the webpage. Accordingly, the spending of user traffic is high, and a large amount of Internet resources is used, which is disadvantageous for the effective use of Internet resources. When the signal of the Internet is unstable or the webpage communication is interrupted, the user is unable to update or browse new webpage contents.

### SUMMARY

This section provides a general summary of the disclosure, and is not a comprehensive disclosure of its full scope or all of its features.

Various embodiments provide a webpage browsing method and device, so as to decrease the spending of user traffic and improve browsing experiences of user.

The webpage browsing method includes:

accessing, by a browser of a mobile terminal device, a server through Internet in a first working state;

downloading data of a current page and data of predefined N pages subsequent to the current page orderly from the server, caching the downloaded data and displaying the current page, wherein N is a natural number;

updating a link address of each page on the server into a cache address corresponding to data of the page;

disconnecting the Internet after the data of the current page and the data of the N pages subsequent to the current page have been cached; and

switching the browser to a second working state, selecting one page of the cached current page and the N pages subsequent to the current page, reading the data of the selected page from a cache memory according to a cache address corresponding to data of the selected page, and displaying the selected page.

A webpage browsing device includes:

a downloading module to download data of a current page and data of predefined N pages subsequent to the current page orderly from a server when a browsing module is in a first working state, wherein N is a natural number;

a caching module to receive the data downloaded by the downloading module, assign a cache address to data of each page and cache the downloaded data;

the browsing module to access the server through Internet in the first working state, read data of a selected page from the caching module in a second working state according to a cache address corresponding to the data of the selected page, output the read data and disconnect from the Internet after the data of the current page and the data of the N pages subsequent to the current page have been cached;

an updating module to update, according to the cache address assigned to the data of each page by the caching module, a link address of the page on the server into the cache address;

a state switching module to switch the browsing module from the first working state to the second working state, or switch the browsing module from the second working state to the first working state; and

a displaying module to receive the data output by the browsing module, and display the selected page.

By the webpage browsing method and device provided by various embodiments, the browser may download the data of other pages when the user browses a certain page, and is disconnected from the Internet after finishing the downloading. In this way, the bandwidth resources of the Internet may be saved, and the spending of user traffic may be decreased. Through caching the downloaded page data, the user may browse the cached page data even if the signal of the Internet is unstable or the webpage communication is interrupted, which facilitates improvement in the browsing experiences of user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for browsing rich text through a browser of a mobile terminal device.

FIG. 2 is a flowchart illustrating a webpage browsing method according to various embodiments.

FIG. 3 is a flowchart illustrating a working process of browser in a first working state according to various embodiments.

FIG. 4 is a flowchart illustrating a working process of browser in a second working state according to various embodiments.

FIG. 5 is a block diagram illustrating the structure of a webpage browsing device according to various embodiments.

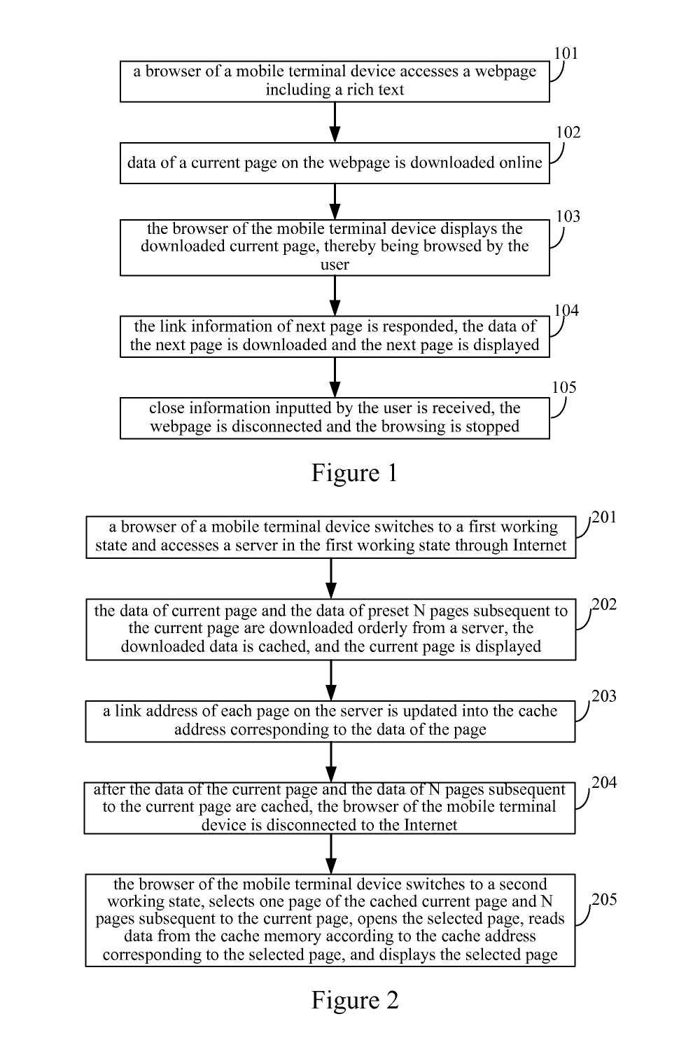

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

FIG. 2 is a flowchart illustrating a webpage browsing method according to various embodiments. Referring to FIG. 2, the method includes following blocks 201-205.

At block 201, a browser of a mobile terminal device switches to a first working state and accesses a server in the first working state through Internet.

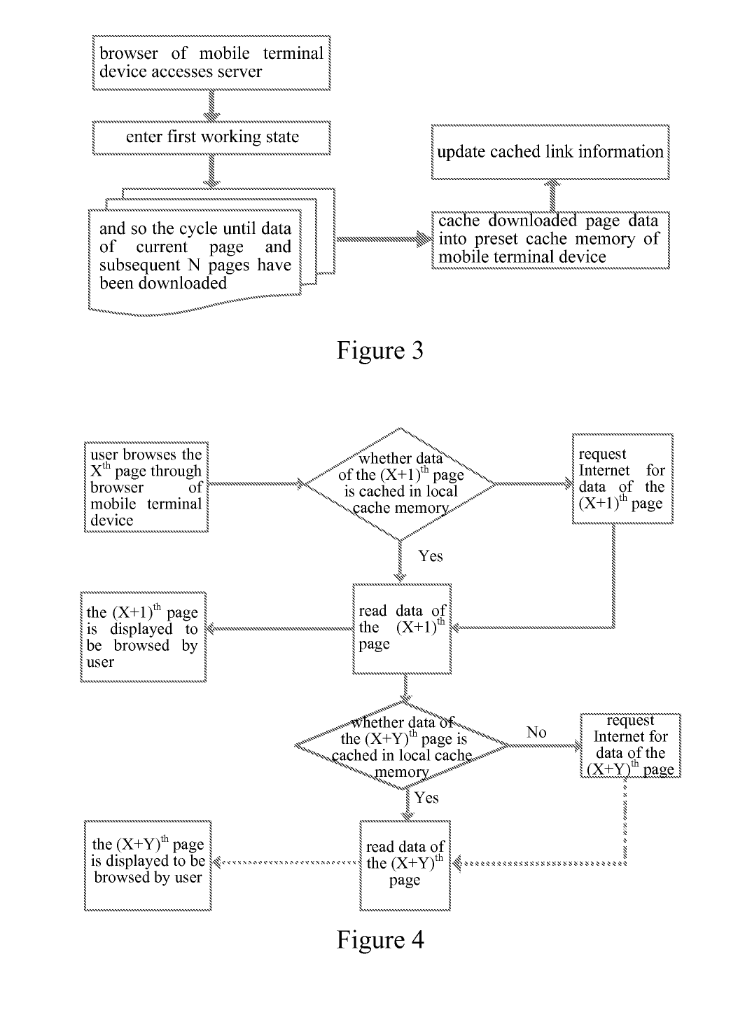

As shown in FIG. 3, a user clicks the browser of the mobile terminal device, for example, clicks a reading mode switching button on the browser of the mobile terminal device. At this time, the browser of the mobile terminal device switches to an offline downloading mode, i.e., the first working state. The browser of the mobile terminal device is connected to a webpage, and accesses the webpage according to a to-be-accessed link address input by the user, and downloads the data of a rich text data included in the webpage.

In an implementation, after being connected to the webpage and accessing the webpage in the offline downloading mode, the browser of the mobile terminal device may obtain traffic information and bandwidth information to determine a state of Internet environment where the user is located. When the state of the Internet environment is unsatisfied, the browser of the mobile terminal device online downloads the data of current page of the rich text included in the webpage. If the state of the Internet environment is satisfied, block 202 is performed. Herein, the state of the Internet environment being satisfied includes at least one case of the tariff of access point being cheap, network speed being fast, and a channel being unoccupied. The state of the Internet environment being unsatisfied includes at least one case of the tariff of access point being expensive, the network speed being slow, and the channel being occupied.

In the current Internet environment, when the access point is a Wireless Fidelity (WIFI) access point, block 202 may be performed because the tariff of accessing the WIFI access point is free and the network speed is fast.

At block 202, the data of current page and the data of preset N pages subsequent to the current page are downloaded in order from a server, the downloaded data is cached, and the current page is displayed.

Referring to FIG. 3, the browser of the mobile terminal device obtains the data of the current page and the data of N pages subsequent to the current page from the server. N is a natural number. For example, when the user browses a home page of chapter novel, a prompt may pop up from the home page to ask the user whether to download page data and how many pages are to be downloaded. When the user inputs the number of to-be-downloaded pages, the browser of the mobile terminal device begins to download the page data, and caches the downloaded page data orderly into a preset cache memory. The data of each page corresponds to a unique cache address of the cache memory.

At block 203, a link address of each page on the server is updated into the cache address corresponding to the data of the page.

At block 204, after the data of the current page and the data of N pages subsequent to the current page are cached, the browser of the mobile terminal device is disconnected from the Internet.

In this block, after the data of preset N pages subsequent to the current page has been downloaded, the browser of the mobile terminal device is disconnected from the Internet, thereby decreasing the spending of user traffic.

In an implementation, after being disconnected from the Internet, the browser of the mobile terminal device may provide prompting information for the user. The prompting information may prompt the user that the browser enters an offline state.

At block 205, the browser of the mobile terminal device switches to a second working state, selects one page of the cached current pages and N pages subsequent to the current page, opens the selected page, reads data from the cache memory according to the cache address corresponding to the selected page, and displays the selected page.

In various embodiments, the second working state may be an offline reading state of the browser. After being disconnected from the Internet, the browser may automatically switch to the offline reading state, or may be switched to the offline reading state by the user through pressing a button on the interface of the browser.

In an offline reading state, after the user has browsed the displayed current page, the user may click the link control of next page set on the current page. According to the cache address corresponding to the link information of the next page, the browser may obtain the data of the next page from the cache memory, and displays the next page, thereby being browsed by the user.

As shown in FIG. 4, in another offline reading state, the user may browse the rich text by the following processes.

The user browses the X^{th} page through the browser of the mobile terminal device. Herein, X is a natural number.

The browser determines whether the data of the (X+1)^{th} page has been cached into a local cache memory. If the data of the (X+1)^{th} page has not been cached into the local cache memory, the browser requests the Internet for the data of the (X+1)^{th} page. If the data of the (X+1)^{th} page has been cached into the local cache memory, the browser obtains the data of the (X+1)^{th} page.

In this case, if the data of the (X+1)^{th} page has not been cached into the local cache memory, it is indicated that the browser needs to be reconnected to the Internet. Then the browser may download page data from the Internet according to a predefined policy and cache the page data into the local cache memory. For example, the predefined policy may indicate to download N pages every time. After the browser has downloaded the page data, the mobile terminal device automatically disconnects from the Internet.

The browser displays the (X+1)^{th} page, thereby being browsed by the user.

In this case, after the user browses the (X+1)^{th} page and when the user triggers to browse the (X+2)^{th} page, a process similar to the process of determining whether the data of the (X+1)^{th} page has been cached into the local cache memory is performed. Different from the process of determining whether the data of the (X+1)^{th} page has been cached into the local cache memory, it is the data of the (X+2)^{th} page that is determined. The cycle continues until the user triggers to browse the (X+Y)^{th} page, wherein Y is a natural number larger than 1.

The browser determines whether the data of the (X+Y)^{th} page has been cached into the local cache memory. If the data of the (X+Y)^{th} page has not been cached into the local cache memory, the browser requests the Internet for the data of the (X+Y)^{th} page. If the data of the (X+Y)^{th} page has been cached into the local cache memory, the browser obtains the data of the (X+Y)^{th} page and displays the (X+Y)^{th} page, thereby being browsed by the user.

In this case, if the data of the (X+Y)^{th} page has not been cached into the local cache memory, it is indicated that the browser needs to be reconnected to the Internet. Then, the browser may download page data of the rich text included in the webpage again according to the predefined policy and cache the downloaded page data into the local cache memory. After the browser downloads the page data according to the predefined policy, the mobile terminal device automatically disconnects from the Internet.

In the offline reading state, the browser determines whether the data of the selected page has been cached into the cache memory and has a cache address. If the selected page has been cached into the cache memory and has the cache address, the browser reads the data of the selected page from the cache memory according to the cache address, and displays the selected page. If the selected page has not been cached into the cache memory or has no cache address, the browser is reconnected to the Internet.

When the browser of the mobile terminal device is in an offline state, the browser may read page data from the cache memory so that the user browses subsequent N pages. Until reading the data of the last page, the browser of the mobile terminal device tries to reconnect the Internet.

In the webpage browsing method, the browser switches to the first working state and accesses the server through the Internet in the first working state. The browser downloads the data of the current page and the data of the predefined N pages subsequent to the current page in order from the server, caches the downloaded data and displays the current page, wherein N is a natural number. The browser updates the link address of each page on the server into the cache address corresponding to the data of the page. After the data of the current page and the data of the N pages subsequent to the current page have been cached, the browser is disconnected from the Internet. The browser switches to the second working state, selects and opens one page of the cached current page and the N pages subsequent to the current page, reads the data of the selected page from the cache memory according to the cache address corresponding to the selected page, and displays the selected page. In this way, the browser may download the data of other pages when the user browses a certain page, and is disconnected from the Internet after finishing the downloading. When the Internet environment is satisfied, the browser may download non-browsed pages fast. Accordingly, the usability of the browser of the mobile terminal device may be improved greatly, the bandwidth resources of the Internet may be saved, and the spending of user traffic may be decreased. Through caching the downloaded page data and setting the link control of next page on the current page, the user may browse the cached rich text even if the signal of the Internet is unstable or the webpage communication is interrupted, which implements offline browsing and thus improves the browsing experiences of user. Moreover, when the user is to browse the next page, the browser may read the data of the next page from the cache memory without downloading the data of the next page from the server, thereby avoiding the influence of Internet delay on the browsing continuity.

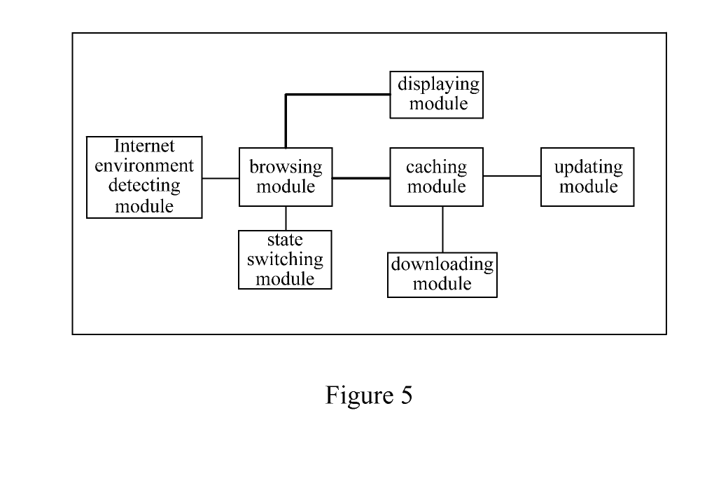

FIG. 5 is a block diagram illustrating the structure of a webpage browsing device according to various embodiments. As shown in FIG. 5, the webpage browsing device includes following modules.

A downloading module downloads data of a current page and data of predefined N pages subsequent to the current page orderly from a server when a browsing module is in a first working state, wherein N is a natural number.

A caching module receives the data downloaded by the downloading module, assigns a cache address to data of each page and caches the downloaded data.

The browsing module accesses the server through the Internet in the first working state, reads data of a selected page from the caching module in a second working state according to a cache address corresponding to the data of the selected page, outputs the read data and disconnects from the Internet after the data of the current page and the data of the N pages subsequent to the current page have been cached.

An updating module updates, according to the cache address assigned to the data of each page by the caching module, a link address of the page on the server into the cache address.

A state switching module switches the browsing module from the first working state to the second working state, or switches the browsing module from the second working state to the first working state.

A displaying module receives the data output by the browsing module, and displays the selected page.

The webpage browsing device further includes an Internet environment detecting module, to detect whether the Internet environment is satisfied, and send a detection result to the state switching module. The Internet environment being satisfied includes at least one case of the tariff of access point being cheap, network speed being fast and a channel being unoccupied.

The methods and modules described herein may be implemented by hardware, machine-readable instructions or a combination of hardware and machine-readable instructions. Machine-readable instructions used in various embodiments disclosed herein may be stored in a storage medium readable by multiple processors, such as a hard drive, CD-ROM, DVD, compact disk, floppy disk, magnetic tape drive, RAM, ROM or other proper storage device, or, at least part of the machine-readable instructions may be substituted by specific-purpose hardware, such as custom integrated circuits, gate array, FPGA, PLD and specific-purpose computers and so on.

A machine-readable storage medium is also provided, which stores instructions to cause a machine to execute a method as described herein. Specifically, a system or apparatus having a storage medium that stores machine-readable program codes for implementing functions of any of the above various embodiments and that may make the system or the apparatus (or CPU or MPU) read and execute the program codes stored in the storage medium.

In this situation, the program codes read from the storage medium may implement any one of the above various embodiments, thus the program codes and the storage medium storing the program codes are part of the technical scheme.

The storage medium for providing the program codes may include a floppy disk, hard drive, magneto-optical disk, compact disk (such as CD-ROM, CD-R, CD-RW, DVD-ROM, DVD-RAM, DVD-RW, DVD+RW), magnetic tape drive, Flash card, ROM and so on. Optionally, the program code may be downloaded from a server computer via a communication network.

Alternatively to the program codes being executed by a computer, at least part of the operations performed by the program codes may be implemented by an operation system running in a computer following instructions based on the program codes to realize a technical scheme of any of the above various embodiments.

In addition, the program codes implemented from a storage medium are written in a storage medium in an extension board inserted in the computer or in a storage medium in an extension unit connected to the computer. In this embodiment, a CPU in the extension board or the extension unit executes at least part of the operations according to the instructions based on the program codes to realize a technical scheme of any of the above various embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A webpage browsing method, comprising:
accessing, by a browser of a mobile terminal device, a server through Internet in a first working state;
downloading data of a current page and data of predefined N pages subsequent to the current page orderly from the server, caching the downloaded data and displaying the current page, wherein N is a natural number;
updating a link address of each page on the server into a cache address corresponding to data of the page;
disconnecting the Internet after the data of the current page and the data of the N pages subsequent to the current page have been cached; and
switching the browser to a second working state, selecting one page of the cached current page and the N pages subsequent to the current page, reading the data of the selected page from a cache memory according to a cache address corresponding to data of the selected page, and displaying the selected page.

2. The method of claim 1, after selecting one page of the cached current page and the N pages subsequent to the current page, further comprising:
determining whether the data of the selected page has been cached and has a cache address; if the selected page been cached and has the cache address, reading the data of the selected page from the cache memory according to the cache address corresponding to the data of the selected page, and displaying the selected page.

3. The method of claim 1, after the browser accesses the server through the Internet in the first working state, further comprising:
determining whether a state of Internet environment is satisfied; if the state of Internet environment is satisfied, downloading the data of the current page and the data of the predefined N pages subsequent to the current page orderly from the server, and caching the downloaded data, wherein the state of Internet environment being satisfied comprises at least one of the tariff of access point being cheap, network speed being fast, and a channel being unoccupied.

4. The method of claim 2, after the browser accesses the server through the Internet in the first working state, further comprising:
determining whether a state of Internet environment is satisfied; if the state of Internet environment is satisfied, downloading the data of the current page and the data of the predefined N pages subsequent to the current page in order from the server, and caching the downloaded data, wherein the state of Internet environment being satisfied comprises at least one of the tariff of access point being cheap, network speed being fast, and a channel being unoccupied.

5. The method of claim 1, wherein the first working state is an offline downloading mode and the second working state is an offline reading state.

6. A webpage browsing device, comprising:
a downloading module to download data of a current page and data of predefined N pages subsequent to the current page orderly from a server when a browsing module is in a first working state, wherein N is a natural number;
a caching module to receive the data downloaded by the downloading module, assign a cache address to data of each page and cache the downloaded data;
the browsing module to access the server through the Internet in the first working state, read data of a selected page from the caching module in a second working state according to a cache address corresponding to the data of the selected page, output the read data and disconnect from the Internet after the data of the current page and the data of the N pages subsequent to the current page have been cached;
an updating module to update, according to the cache address assigned to the data of each page by the caching module, a link address of the page on the server into the cache address;
a state switching module to switch the browsing module from the first working state to the second working state, or switch the browsing module from the second working state to the first working state; and
a displaying module to receive the data output by the browsing module, and display the selected page.

7. The device of claim 6, further comprising an Internet environment detecting module, configured to detect whether Internet environment is satisfied, and send a detection result to the state switching module, wherein the Internet environment being satisfied comprises at least one case of the tariff of access point being cheap, network speed being fast, and a channel being unoccupied.

8. The device of claim 6, wherein the first working state is an offline downloading mode and the second working state is an offline reading state.
